(19) United States
(12) Patent Application Publication
(10) Pub. No.: US 2008/0104767 A1
(43) Pub. Date: May 8, 2008

(54) Chemical Treatment of Animal Skins

(76) Inventors: Alberto Santori, Sant'Elpidio A Mare (IT); Giancarlo Recanati, Sant'Elpidio A Mare (IT)

Correspondence Address: YOUNG & THOMPSON, 209 Madison Street, Suite 500, ALEXANDRIA, VA, 22314, US

(21) Appl. No.: 11/664,094

(22) PCT Filed: Sep. 30, 2004
(86) PCT No.: PCT/IT04/00540

§ 371 Date: May 31, 2007

(51) Int. Cl. C14C 3/10; C14C 1/00; C14C 3/00

(52) U.S. Cl. 8/94.32; 69/30; 8/94.19 R; 8/94.33

(57) ABSTRACT

In a tanning process for tanning animal skins the skin is subjected to a pre-oxidation step.

### FIELD OF THE INVENTION

The present invention refers to a tanning process, for tanning animal skins, which is particularly echological and environment friendly, and to an apparatus to carry out the process.

### BACKGROUND OF THE INVENTION

Tanning process is critical from the standpoint of environment. On one hand, tanning avoids the skin putrefaction, preventing the build up of CO2, which is dangerous for the greenhouse effect. On the other hand, the process usually employs a lot of substances, which are dangerous both for the worker health and for waters, where the outlet is drained.

Tanning process starts from a raw skin, which exhibits poor strength, which can be putrefacted and which shows unregular shape and leads to a final skin having good resiliency, high strength and which is stable with a constant thickness. Usually, the employed skins come from butcher's wastes.

Tanning process can be divided into three phases: a) from raw material to wet blue; b) from wet blue to crust; c) from crust to finished product.

The raw material should be selected so as to be as uniform as possible. The selected raw material is soaked with a mechanical treatment comprising dry drum tannage and a temperature increase, up to 28-30° C., and a chemical treatment, including the addition of bases (e.g. NaOH, Na2CO3, NaHCO3, MgO), the addition of surfactants, antibacterials and protheolithic enzymes (catalysts).

Next step is lime-tip, in order to remove hair and epidermis, to obtain a good, fibrous collagen relaxation and a partial saponification of skin natural fat. In this step the skin is submitted to a treatment with a combination of lime, sulphide and sulphydrate, in the same drum tannages and reels used in the soaking. This step is the most polluting one. Table 1 reports the composition of the pollution.

TABLE 1
Main pollutants in lime-tip step

| Pollutant | Concentration (mg/l) | Concentrations allowed |
|---|---|---|
| Sulphide | 2,000-5,000 | 1 |
| COD | 35,000-45,000 | 100 |
| BOD | 11,000-30,000 | 40 |
| Suspended particles | 25,000-40,000 | 80 |
| Total solids | 70,000-80,000 | 80 |
| pH | 11.0-12.5 | 5.5-9.5 |

Next step is lime removal. The lime deposited onto the surface of the skin is removed with a sufficient amount of water. Chemically bonded lime is removed through weak acids and through organic and inorganic acid salts. The latter sub-step leads pH to 8.3, which is the optimum value for enzymes to work. pH lowering should be as smooth as possible.

Bating is the following step. The use of enzymes removes remaining wastes and improve skin quality. Usually employed enzymes are pancreas enzymes, fungi enzymes and bacteric enzymes.

The skin is subsequently degreased, by adding surfactants and similar.

After degreasing, the skin is pikelled, by buffering strong acids with salts.

The so treated skin is then subjected to tanning. Three classes of tannants are used: polyaromatic tannants, mineral tannants and aliphatic tannants. Polyaromatic tannants can be divided into vegetable tannants and synthetic tannants. Vegetable tannants can be pyrogallol hydrolysed, like oak, chestnut, cherry plum, smoke-bush or valonea wood, and pyrocatechin condensates, like quebracho, mimosa, gambier. Synthetic tannants can be phenolic, like whole substitution tannants, or non-phenolic, like auxiliary and bleaching tannants. Usual mineral tannants are chrome, aluminium or zirconium tannants. Aliphatic tannants are aldehyde tannants, like formaldehyde, glutaric dialdehyde or amido dialdehyde, policondensation products, like methiol melamine, methiol dicyanamide or acrilates or paraffin derivatives, like sulpho chlorinated paraffines or fish oil.

Chrome tanning is by far the most popular tanning in the world. Chrome tanned wet blue are raw skins more and more diffused. A standard is at least 2% chrome, with a pH value between 3.5 and 4. The whole process needs from 48 to 96 hours. Therefore, it is apparent that a faster process, involving a smaller production of pollutants is strongly sought.

Another known process is described in PCT/IB00/01816. In such a process, a skin is treated after carrying it on a supporting plate which is introduced into a container, which is kept under vacuum during the introduction of a liquid mixture. Although such a process tries to perform as environment friendly, it is very complicate to carry out, very expensive and leads to very poor results.

### SUMMARY OF THE INVENTION

The present invention refers to a tanning process for tanning animal skins, characterised in that the skin is subjected to a pre-oxidation step.

### BRIEF DESCRIPTION OF THE DRAWINGS

FIG. 1 is a side-view, partially in section, of a drum according to this invention; and

FIG. 2 shows a detail of FIG. 1.

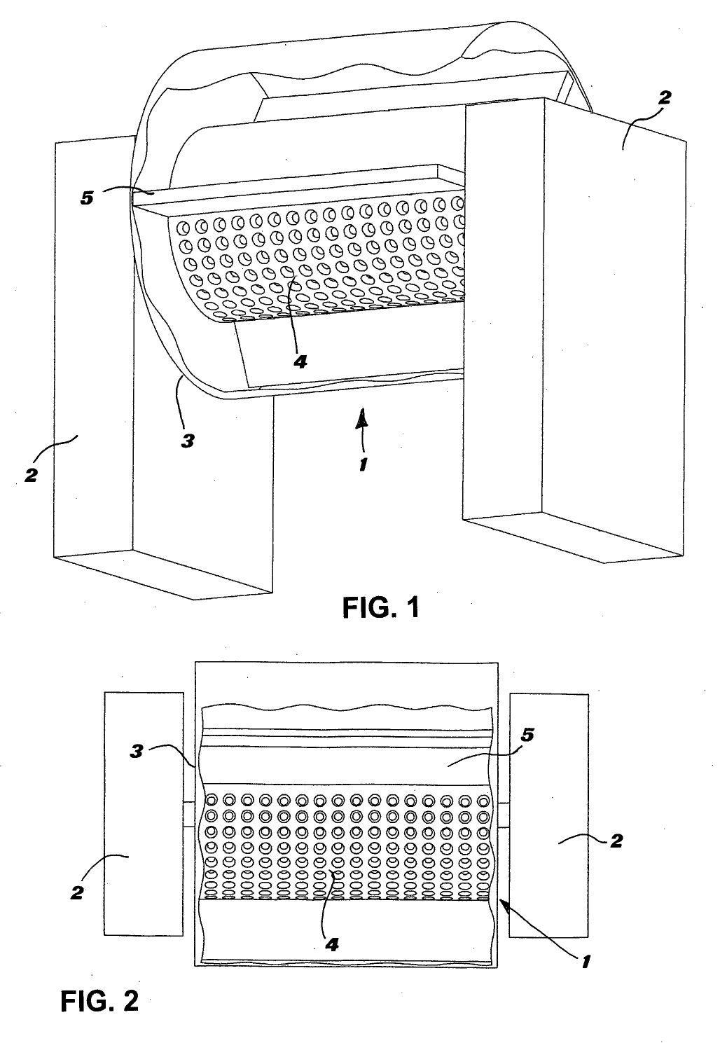

### BEST WAY OF CARRYING OUT THE INVENTION

The inventive process for tanning animal skins involves a pre-oxidation step. All percentages reported in the following are by weight. Process conditions are to be calibrated on the particular skin to be tanned. The skin is washed at 27° C. in water, sodium carbonate (0.2%), ozonised water and thioglycolic acid, in order to make a complete dehaving and a partial dissolution of the back hidden fleshings. Preferably, sodium carbonate is 2.9-3.3%, ozonised water is 1-1.2% (giving 0.35 moles of O₂ per liter of solution and thioglycolic acid is 0.5%, the remainder (or hydrogen peroxide) being water. The solution is added in ca. 20 minutes, using a revolving drum 1. The revolving drum 1 according to this invention is represented in the drawings. It comprises two supports 2, which are integral with an internal core 3. Preferably, the said core 3 is cylindric. It accommodates a series 4 of ultra-sonic devices. About the core 3, some rotating blades 5 are provided. The drum 1 is connected to an ozone supplier, if ozonised water is the selected oxidating agent. The ozone supplier could be connected to a recycling water pipe, in order to remove the hair suspended in the water.

The diametre of the core 3 is chosen so that water, which should in any case equal the weight of the skin, in any case keeps the series 4 under its surface, so as not to shock ultra-sonic devices.

During the operation, the drum 1 is full of water and of the above solution. Preferably, ozone is bubbled in the water. The motion of the skin is performed by blades 5, which are connected to the core 3. Ultra-sonic devices are activated.

Subsequently, the treatment lasts for 7 hours with ultrasounds, at 23-25° C. Ultrasound frequency is properly chosen depending on the skin thickness. Thereafter, temperature should never be over 28° C. Oxidation agents other than ozonised water (or hydrogen peroxide) can be chosen, from the group consisting of fluorine, oxygen, ozone, nitric acid, sodium perborate and sulphuric acid. In any case, ozonised water is particularly preferred, since it gives no harmful waste.

Then, the pre-oxidated skin is treated with acids and possibly oxidised in acid environment.

As it can be easily be seen, no pollutant, or less pollutant than in conventional tanning processes is introduced. A comparison between pollutant in conventional processes and in the inventive one is reported in Table 2.

TABLE 2
comparison between conventional and inventive process

| | | inventive |
|---|---|---|
| Pollutant | present lime-tip (mg/l) | process (mg/l) |
| sulphyde | 2,000-5,000 | No |
| COD | 35,000-45,000 | 10,000-12,000 |
| suspended particles | 25,000-40,000 | 2,000 |
| total particles | 70,000-80,000 | 5,000-7,000 |
| chloride | 3 | no (with buffered acids) |

Since the inventive process does not involve toxic amounts of substances, the stripped fleshings can be used, in order to prepare fertilisers, animal food or similar. It is also possible to avoid the use of surfactants, like nonylphenols.

Preferably, non-toxic dyes are used to dye the tanned skin. Among them, food dyes, like anylines, are preferred as well as some vegetable extracts. Preferably, they are employed in an amount of 2-3 wt. %. The skin is rotated for 180 minutes in a revolving drum.

During each step of the inventive process, the temperature should be controlled, so as not to increase above 28-30° C. An additional, optional step is to remove the hair by immunisation, without its destruction. In this way hair is in the flesh and it gives rise to no COD. In order to bate the skin, pH should be lowered up to 8-8.5. The oxidation step can be carried out both in acid, neutral and basic environment. Last step is tanning. Tanning is usually performed in two steps. First step is the so-called neutral tanning. It could be based either on silicates, or on caoutchouc, or on vegetables or on a combination thereof. The combination of vegetable and caoutchouc based tanning is preferred. It is preferably carried out in a bath containing H2O, 10% Tara extract and 4% caoutchou extract; the skin is rotated for 120 minutes in a revolving drum, up to a final pH of 3.8.

The second step is the so-called post tanning. After pressing and shaving skin, it is kept at a temperature of 45-47° C. It is degreased with a natural extract, for instance a fish extract. The extract is preferably employed as 7-8 wt. % of the shaved skin.

Between the two steps of tanning, the skin is broken and shaved, so as to recover the shaving without environmental problems.

The skin obtained according to this invention exhibits features, which are new and never found in the market.

Summing up, the present invention provides a new tanned skin, through an environment friendly process, which allows even a time saving in the processing (up to 50%).

1-24. (canceled)

25. A tanning process for tanning animal skins, characterised in that the skin is subjected to a pre-oxidation step.

26. A process as in claim 25, characterised in that pre-oxidation solution is added in ca. 20 minutes in a revolving drum.

27. A process as in claim 26, characterised in that said pre-oxidation step is carried out in the presence of ultra-sounds.

28. A process as claimed in claim 27, characterised in that during pre-oxidation step, skin is washed at 27° C. in water, sodium carbonate (0.2%) hydrogen peroxide or ozonised water and thioglycolic acid.

29. A process as in claim 28, characterised in that sodium carbonate is 2.9-3.3%, ozonised water is 1-1.2% and thioglycolic acid is 0.5%.

30. A process as claimed in claim 27, characterised in that the pre-oxidation step is carried out with an oxidation agent chosen in the group consisting of hydrogen peroxide fluorine, oxygen, ozone, nitric acid, sodium perborate and sulphoric acid.

31. A process as claimed in claim 30, characterised in that it further comprises the step of an acid treatment.

32. A process as claimed in claim 31, characterised in that it further comprises an acid oxidation step.

33. A process as in claim 32, characterised in that it includes a step of neutral-tanning.

34. A process as in claim 33, characterised in that such step of neutral-tanning is based on silicates, caoutchouc, vegetables or on a combination thereof.

35. A process as in claim 34, characterised in that neutral-tanning step is based on a combination of vegetable tannants and caoutchouc.

36. A process as in claim 35, characterised in that said neutral-tanning is carried out with a bath containing H2O, 10% Tara extract and 4% caoutchouc extract.

37. A process as in claim 36, characterised in that skin dyeing is carried out with a non-toxic dye.

38. A process as in claim 37, characterised in that such dye is a food dye, like anylines.

39. A process as in claim 38, characterised in that temperature is controlled in order to be not higher than 28-30° C.

40. A process as in claim 39, characterised in that during the bating step pH is controlled at 8-8.5.

41. A process as claimed in claim 40, characterised in that, between the steps of tanning the skin is broken and shaved, so as to recover the shaving without environmental problems.

42. A skin obtained with a process according to claim 41.

43. Revolving drum (1) for use in a tanning process, comprising two supports (2), characterised in that it further includes an internal core (3).

44. Revolving drum as claimed in claim 43, characterised in that the said core (3) has cylindric shape.

45. Revolving drum (1) as claimed in claim 44, characterised in that the said core (3) is integral with the said supports (2).

46. Revolving drum as claimed in claim 45, characterised in that the said core (3) carries a series (4) of ultra-sound sources.

47. Revolving drum (1) as claimed in claim 46, characterised in that it comprises some rotating blades (5) around the core (3).

48. Revolving drum (1) as claimed in claim 47, characterised in that the diametre of the core (3) is such that the surface of the water contained in the drum (1) is always over the series (4) of ultra-sound sources.

49. Revolving drum (1) as claimed in claim 48, characterised in that it includes an ozone supplier.
